(19) United States
(12) Patent Application Publication
(10) Pub. No.: US 2025/0189329 A1
(43) Pub. Date: Jun. 12, 2025

(54) NAVIGATION SYSTEM BASED ON ROUTINE WIDGET AND A METHOD FOR OPERATING THE SAME

(71) Applicant: HYUNDAI AUTOEVER CORP., Seoul (KR)

(72) Inventors: Ji Young Han, Seoul (KR); Hee Eun Lee, Seoul (KR); Won Heung Jo, Seoul (KR); Esther Choi, Seoul (KR); Joo Ho Chae, Seoul (KR); Il Kyun Kim, Seoul (KR); Min Jeong Kim, Seoul (KR); Yeon Kyung Chung, Seoul (KR); Hwa Hyeon Hong, Seoul (KR); Rak Jun Sung, Seoul (KR)

(73) Assignee: HYUNDAI AUTOEVER CORP., Seoul (KR)

(21) Appl. No.: 18/958,967

(22) Filed: Nov. 25, 2024

(30) Foreign Application Priority Data
Dec. 11, 2023 (KR) 10-2023-0178466

(51) Int. Cl. G01C 21/34; G06F 3/0486; G06F 9/50

(52) U.S. Cl. CPC G01C 21/3484; G06F 3/0486; G06F 9/5038

(57) ABSTRACT

A method for operating a navigation system is performed by a computing device and may include: adding one or more routine widgets indicating a routine of a user to a widget slot of the navigation system; determining an execution order of the added routine widget; and executing the routine widget based on the determined execution order to perform an operation corresponding to the routine.

### CROSS-REFERENCE TO RELATED APPLICATION

This application claims priority to Korean Patent Application No. 10-2023-0178466, filed on Dec. 11, 2023 in the Korean Intellectual Property Office, and all the benefits accruing therefrom under 35 U.S.C. 119, the contents of which in its entirety are herein incorporated by reference.

### BACKGROUND

### Field

The present disclosure relates to a navigation system based on a routine widget and a method for operating the same.

### Description of Related Art

Generally, each of various mobility apparatuses employs a navigation system equipped with a GPS (Global Positioning System) to identify a current location and a current moving speed thereof or to determine a moving speed thereof. The navigation system receives a radio wave indicating a latitude, a longitude, an altitude, etc. from a plurality of artificial satellites, calculates a current location of a moving object to identify the current location of the moving object, and identifies a destination input by a user. The navigation system determines a route and travel time from the current location to the destination.

The navigation system determines the route based on various information related to driving, such as a distance to the destination, an estimated arrival time, an optimal distance to the destination, the shortest distance, cost, a traffic condition, use of free or toll road, etc. The navigation system includes not only a component for receiving the destination directly from the user, but also a component that searches for the current location or the surroundings around the destination, and a component that recommends a stopover point.

The navigation system does not simply perform a function of providing the shortest route to the destination for the user, but may perform various additional functions while interoperating with a user device such as a smartphone and a smart watch. In particular, a method is being studied to recommend a destination or a stopover point, or to control the vehicle or the user device, based on information related to the user's schedule created and managed by the user device, thereby enhancing a satisfaction level of autonomous driving experience.

The statements in this Background section merely provide background information related to the present disclosure and may not constitute prior art.

### SUMMARY

A technical purpose to be achieved using embodiments of the present disclosure is to provide a method in which a routine widget generated in a user device is added to a widget slot of a navigation system, and the navigation system automatically processes an operation corresponding to a user's routine.

Furthermore, a technical purpose to be achieved using embodiments of the present disclosure is to provide a method for determining an execution order of a plurality of routine widgets when the plurality of routine widgets are added.

The technical purposes of the present disclosure are not limited to the technical purposes mentioned above, and other technical purposes not mentioned may be clearly understood by those having ordinary skill in the art from descriptions as set forth below.

According to an aspect of the present disclosure, a method for operating a navigation system is performed by a computing device and may include: adding at least one routine widget indicating a routine of a user to a widget slot of the navigation system; determining an execution order of the added routine widget (i.e., the at least routine widget); and executing the at least routine widget based on the determined execution order to perform an operation corresponding to the routine of the user.

In an embodiment, the user's routine may include at least one of a personal schedule of the user, contents periodically played by the user, a place periodically visited by the user, or a periodic SNS (Social Network Service) activity of the user. The at least routine widget includes detailed information about the routine.

In an embodiment, when detailed information of the at least one routine widget is modified in a user device and the at least one routine widget includes a plurality of routine widgets, the modification may be equally applied to the plurality of routine widgets added to the widget slot.

In an embodiment, the adding of the at least one routine widget to the widget slot may include: loading the at least one routine widget from a user device; and dragging the at least one loaded routine widget to the widget slot to add the at least one routine widget thereto.

In an embodiment, the at least one routine widget includes a plurality of routine widgets, and determining the execution order of the at least one routine widget may include: determining that an execution order of a routine widget related to a schedule among the plurality of routine widgets, has priority over an execution order of other routine widgets of the plurality of routine widgets; determining an execution order of a routine widgets including temporal information, among the other routine widgets, based on a temporal order thereof; and determining an execution order of a routine widget free of the temporal information, among the other routine widgets, based on a past routine pattern of the user.

In an embodiment, executing the at least one routine widget to perform the corresponding operation thereto may include: when the at least one routine widget is a routine widget related to a schedule, recommending a destination or stopover point corresponding to the schedule; and guiding the user along a route to the recommended destination or stopover point in response to the user's approval to the recommendation.

In an embodiment, executing the at least one routine widget to perform the corresponding operation thereto may include: when the at least one routine widget is a routine widget related to contents, recommending playing the contents corresponding to the at least one routine widget; and controlling a user device or a vehicle to play the recommended contents in response to the user's approval to the recommendation.

In an embodiment, executing the routine widget to perform the corresponding operation thereto may include: when the at least one routine widget is a routine widget related to SNS (Social Network Service), recommending checking a new post on the SNS corresponding to the at least one routine widget; and controlling the user device to read the new post aloud in response to the user's approval to the recommendation.

According to another aspect of the present disclosure, a computing device may comprise: a processor; and a memory storing therein instructions, wherein when the instructions are executed by the processor, the instructions may cause the processor to add at least one routine widget indicating a routine of a user to a widget slot of a navigation system; determine an execution order of the at least one routine widget; and execute the at least one routine widget based on the determined execution order to perform an operation corresponding to the routine.

In an embodiment, adding the at least one routine widget to the widget slot may include: loading the at least one routine widget from a user device; and dragging the at least one loaded routine widget to the widget slot to add the loaded routine widget thereto.

In an embodiment, the at least one routine widget includes a plurality of routine widgets, and determining the execution order of the at least one routine widget may include: determining that an execution order of a routine widget related to a schedule, among the plurality of routine widgets, has priority over an execution order of other routine widgets than the routine widget related to the schedule; determining an execution order of a routine widget including temporal information, among the other routine widgets, based on a temporal order thereof; and determining an execution order of a routine widget free of the temporal information, among the other routine widgets, based on a past routine pattern of the user.

In an embodiment, executing the at least one routine widget to perform the corresponding operation thereto may include: when the at least one routine widget is a routine widget related to a schedule, recommending a destination or stopover point corresponding to the schedule; and guiding the user along a route to the recommended destination or stopover point in response to the user's approval to the recommendation.

In an embodiment, executing the routine widget to perform the corresponding operation thereto may include: when the at least one routine widget is a routine widget related to contents, recommending playing the contents corresponding to the at least one routine widget; and controlling a user device or a vehicle to play the recommended contents in response to the user's approval to the recommendation.

In an embodiment, executing the at least one routine widget to perform the corresponding operation thereto may include: when the at least one routine widget is a routine widget related to SNS (Social Network Service), recommending checking a new post on the SNS corresponding to the at least one routine widget; and controlling the user device to read the new post aloud in response to the user's approval to the recommendation.

According to still another aspect of the present disclosure, a system may comprise: a mobility apparatus; a user device configured to generate a plurality of routine widgets indicating a routine of a user; and a navigation system configured to: load and add the plurality of routine widgets to a widget slot; determine an execution order of the plurality of routine widgets added to the widget slot; and execute the plurality of routine widgets based on the determined execution order to perform a corresponding operation thereto.

In an embodiment, when detailed information of the plurality of routine widgets is modified in the user device, the modification may be equally applied to the plurality of routine widgets added to the widget slot of the navigation system.

In an embodiment, the navigation system may be further configured to: determine that an execution order of a routine widget related to a schedule, among the plurality of routine widgets, has priority over an execution order of other routine widgets, which are not related to the schedule among the plurality of routine widgets; determine an execution order of a routine widget including temporal information, among the plurality routine widgets, based on a temporal order thereof; and determine an execution order of a routine widget free of the temporal information, among the plurality of routine widgets, based on a past routine pattern of the user.

In an embodiment, the navigation system may be further configured to: when a routine widget among the plurality of routine widgets is related to a schedule, recommend a destination or stopover point corresponding to the schedule; and guide the user along a route to the recommended destination or stopover point in response to the user's approval to the recommendation.

In an embodiment, the navigation system may be further configured to: when a routine widget among the plurality of routine widgets is related to contents, recommend playing the contents corresponding to the routine widget; and control the user device or the mobility apparatus to play the recommended contents in response to the user's approval to the recommendation.

In an embodiment, the navigation system may be further configured to: when a routine widget among the plurality of routine widgets is related to SNS (Social Network Service), recommend checking a new post on the SNS corresponding to the routine widget; and control the user device to read the new post aloud in response to the user's approval to the recommendation.

### BRIEF DESCRIPTION OF DRAWINGS

The above and other aspects and features of the present disclosure should become more apparent by describing in detail illustrative embodiments thereof with reference to the attached drawings, in which:

FIG. 1 is a schematical diagram illustrating an environment to which a navigation system based on a routine widget according to some embodiments of the present disclosure may be applied;

FIG. 2 shows an example of a routine widget setting screen of the navigation system of FIG. 1;

FIG. 3 shows an example of a case in which a routine widget is added to the routine widget setting screen of FIG. 2;

FIGS. 4 to 5 illustrate examples of routine widget execution screens of the navigation system of FIG. 1;

FIG. 6 is a flowchart illustrating a method for operating a navigation system based on a routine widget according to some embodiments of the present disclosure.

FIG. 7 is a flowchart illustrating a step for determining an execution order of the routine widget of FIG. 6;

FIGS. 8 to 10 are flowcharts illustrating specific examples of a step of processing an operation corresponding to the routine widget; and

FIG. 11 is a block diagram illustrating a hardware configuration of a computing device in which a navigation system based on a routine widget according to some embodiments of the present disclosure is implemented.

### DETAILED DESCRIPTIONS

Some embodiments of the present disclosure are hereinafter described in detail with reference to the accompanying drawings. The advantages, features, and methods of achieving them of the present disclosure should become clearer with the embodiments described in detail along with the accompanying drawings. However, the present disclosure is not limited to the embodiments described below and can be implemented in various different forms. These embodiments are provided only to make the disclosure complete and fully inform those of ordinary skill in the technical field to which the present disclosure belongs, and the present disclosure is defined only by the scope of the claims.

It is noted that the same reference numerals are used for the same elements across different drawings as far as possible. Furthermore, in describing the present disclosure, detailed descriptions of known configurations or functions are omitted when they may obscure the essence of the present disclosure.

Unless defined otherwise, all terms used herein (including technical and scientific terms) can have the meaning commonly understood by one of ordinary skill in the art to which the present disclosure belongs. Terms defined in commonly used dictionaries are not interpreted in an ideal or excessive manner unless explicitly defined otherwise. The terms used in the present specification are for the purpose of describing particular embodiments only and are not intended to limit the present disclosure. In this specification, the singular forms include plural forms unless the context clearly indicates otherwise.

Furthermore, in describing the components of the present disclosure, terms such as first, second, A, B, (a), (b), etc., may be used. These terms are intended to distinguish the components from others, and the essence, order, or sequence of such components is not limited by these terms. If a component is stated as being “connected,” “coupled,” or “linked” to another component, the component can be directly connected or linked to the other component, but it should be understood that there may also exist other components “connected,” “coupled,” or “linked between them. In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. When a component, device, element, or the like of the present disclosure is described as having a purpose or performing an operation, function, or the like, the component, device, or element should be considered herein as being “configured to” meet that purpose or to perform that operation or function.

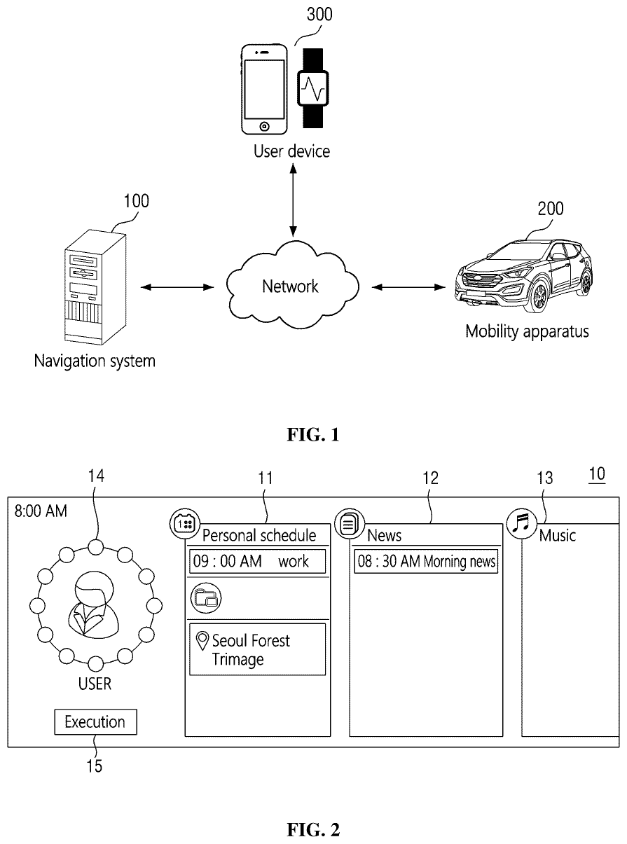

FIG. 1 is a schematic diagram illustrating an environment in which a navigation system 100 based on a routine widget according to some embodiments of the present disclosure may be applied. The navigation system 100 may receive information related to a user's routine in the form of a widget via communication with a mobility apparatus 200 and a user device 300, and execute the received widget to perform an operation corresponding to the routine. For convenience of description as set forth below, the mobility apparatus 200 is assumed to be a vehicle. However, the present disclosure is not limited thereto.

According to some embodiments of the present disclosure, the navigation system 100 may receive the widget representing the user's routine (hereinafter referred to as a routine widget) from the user. In the present disclosure, the routine may refer to the user's typical or habitual activities, schedules, or travel patterns, such as the user's personal schedule (e.g., commuting to work and returning home from work), contents that the user plays periodically (e.g., news, radio, foreign language classes, music, etc.), places that the user visits periodically, the user's periodic leisure activities, and the user's periodic SNS activities. The routine widget may include detailed information about such routines (e.g., information about a work place, a start time of the news being watched, a watching platform, and places that the user visits periodically, etc.). The routine widget may be created and managed in the user device 300. The routine widget may be loaded from the user device 300 and added to a widget slot on the navigation system 100.

After a plurality of routine widgets are added to the widget slot on the navigation system 100, an execution order of the routine widgets may be determined. The execution order of the routine widgets may be determined based on types of the routine widgets, temporal information included in the routine widgets, and the user's past routine pattern. First, the routine widget related to the schedule may be executed at top priority over other types of routine widgets. The execution order of the routine widgets related to the schedules may be determined based on whether a location related to the schedule is a final destination or a stopover point. Further, when there are two or more routine widgets related to the stopover points, the execution order thereof may be determined based on a time of the schedule corresponding thereto. For example, a first routine widget related to a leaving-from-work schedule and a second routine widget related to exercise after the leaving-from-work may be added. In this case, both the first and second routine widgets include locations. Thus, the first routine widget may be executed first to set the destination as home, and then the second routine widget may be executed to set the exercise location as the stopover point. When a third routine widget related to shopping is added, the execution order of the second routine widget and the third routine widget may be determined based on the order of the exercise time and the shopping time.

After the execution order of the routine widgets related to the schedules has been determined, the execution order of the remaining routine widgets (e.g., widgets related to contents playback, etc.) may be determined first based on a temporal order thereof. For example, a first routine widget related to a go-to-work schedule, a second routine widget related to morning news playback, and a third routine widget related to radio playback may be added. In this case, the first routine widget related to the schedule may be executed first and the destination may be set as the work location. Then, the execution order may be determined so that the routine widget temporally earlier among the second and third routine widgets is executed first. For example, when the morning news watching starts at 8:30 AM and the radio listening starts at 9 AM, the execution order may be determined so that the second routine widget is executed before the third routine widget.

In one example, the execution order of the routine widgets that do not include temporal information may be determined based on the user's past routine pattern. For example, it is assumed that a first routine widget related to a foreign language lecture provided in a video streaming service and a second routine widget related to playing a popular chart provided in a music streaming service are added. Referring to the user's past routine pattern, a frequency at which the user plays the popular chart after listening to the foreign language lecture is higher than a frequency at which the user listens to the foreign language lecture after playing the popular chart. In this case, the execution order may be set such that the first routine widget may be executed before the second routine widget. However, despite the above-described embodiments, the execution order of the routine widgets may be arbitrarily determined by the user.

After the execution order of the plurality of routine widgets has been determined, the navigation system 100 may execute each of the routine widgets to perform a corresponding operation thereto. For example, the navigation system 100 may recommend a place related to the schedule as a destination or a stopover point based on a routine widget related to a personal schedule or a routine widget related to a periodic visit. In response to the user approving the recommendation, the navigation system 100 may guide the user along a route to the recommended destination or stopover point. Furthermore, the navigation system 100 may recommend playing the contents (e.g., news, radio, foreign language lecture, music, etc.) according to the routine widget related to the contents playback. In response to the user approving the recommendation, the navigation system 100 may control the contents to be played in the vehicle 200 or the user device 300. In addition, according to the routine widget related to the SNS activity, when new posts are updated on the SNS, the navigation system 100 may control the user device 300 to read the updated posts aloud.

Furthermore, the added routine widget may be associated with the user device 300 and may be continuously updated based on the association. For example, when the time or place of the routine widget related to the user's personal schedule among the added routine widgets is modified on the user device 300, the modification may also be applied to the navigation system 100. Furthermore, the application of the added routine widget to the navigation system 100 may optionally be stopped or the added routine widget may be deleted from the widget slot.

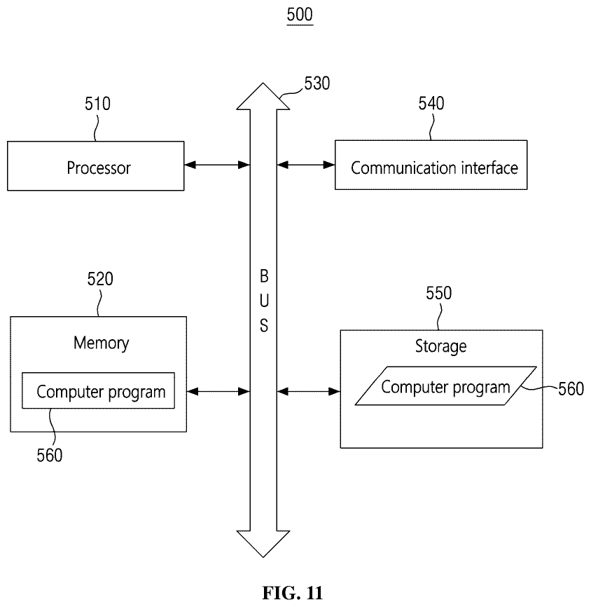

According to some embodiments of the present disclosure, the navigation system 100 may be implemented on at least one computing device. For example, all functions of the navigation system 100 may be implemented on one computing device. Alternatively, some functions of the navigation system 100 may be implemented on a first computing device, and the remaining functions thereof may be implemented on a second computing device. Alternative, a specific function of the navigation system 100 may be implemented on a plurality computing devices. For example, a stopover point recommendation function of the navigation system 100 and a function of displaying information about the destination thereof may be implemented separately on different computing devices. The computing device may include any device equipped with a computing means and a communication means. An embodiment in which the navigation system 100 is implemented as a computing device is described in more detail with reference to FIG. 11.

The user device 300 may be any personal computing device used by the user of the vehicle 200. For example, the user device 300 may include a smart phone, a smart watch, a tablet, a desktop, a laptop, etc. However, the present disclosure is not limited thereto, and the user device 300 may be embodied as any computing device equipped with a computing means and a communication means. As described above, the navigation system 100 may communicate with the user device 300 and use usage history stored in the user device 300 as user information.

Furthermore, the components illustrated in FIG. 1 may communicate with each other through a network. For example, the network may be embodied as any type of a wired/wireless network such as a local area network (LAN), a wide area network (WAN), a mobile radio communication network, and Wibro (Wireless Broadband Internet). Furthermore, the navigation system 100, the mobility apparatus 200, and the user device 300 as illustrated in FIG. 1 may constitute a single computing system that communicates with each other through a network.

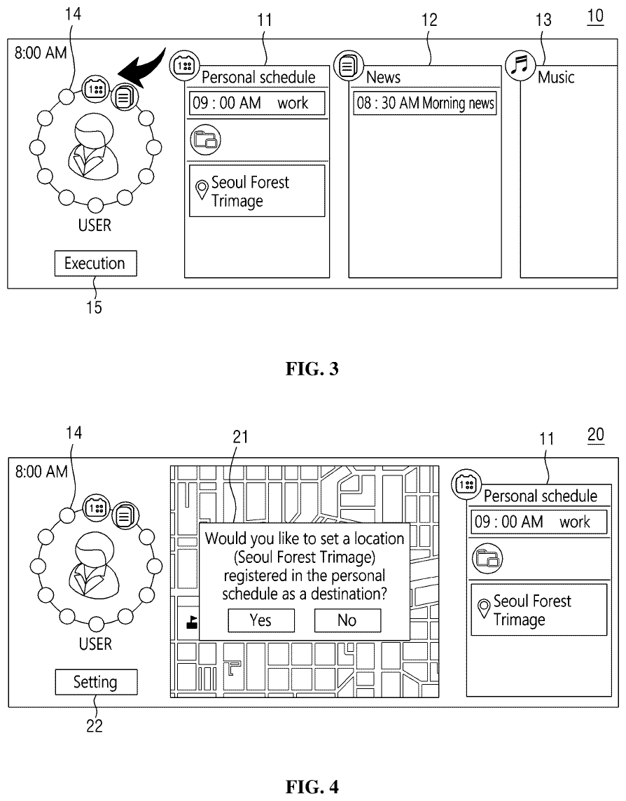

Referring to FIGS. 2 to 5, a user interface of the navigation system 100 based on the routine widget is described below.

FIG. 2 shows an example of a routine widget setting screen 10 of the navigation system 100 of FIG. 1. Referring to FIG. 2, routine widgets 11, 12, and 13 loaded from the user device 300 and a widget slot 14 are shown. The routine widgets 11, 12, and 13 include a personal schedule widget 11, a news widget 12, and a music widget 13 as shown in FIG. 2. In the personal schedule widget 11, a time, a location, and simple description of the schedule are displayed. In the news widget 12 and the music widget 13 related to the contents, detailed information related thereto may be displayed. In FIG. 2, a start time of the news is shown in the news widget 12 by way of example. In the routine widget related to the contents, additional detailed information such as a platform on which the contents will be played and a total playing time of the contents in addition to the information as shown in FIG. 2 may be displayed. The widget slot 14 in FIG. 2 is shown as being empty.

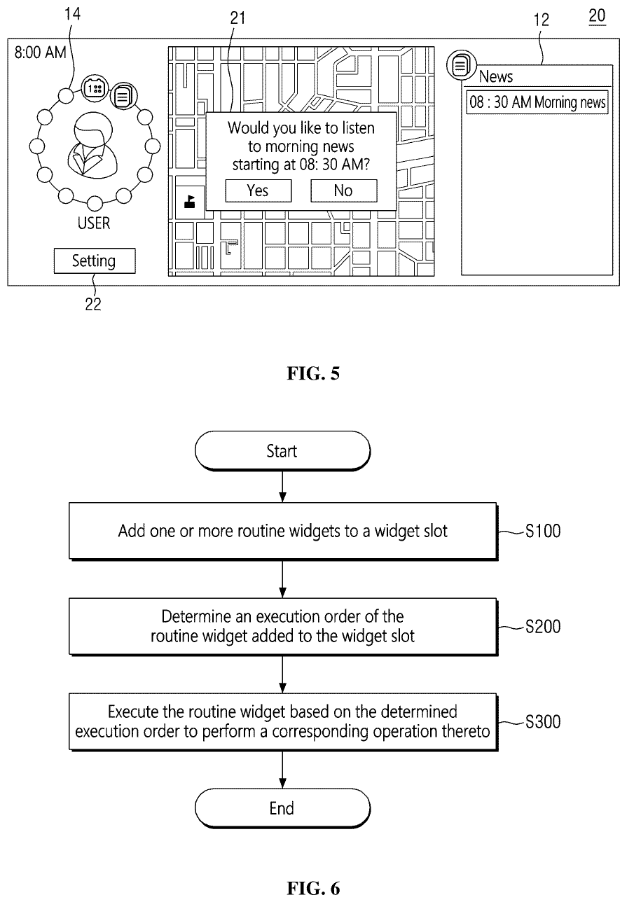

FIG. 3 shows an example of a case where a routine widget is added to the routine widget setting screen 10 of FIG. 2. The user may drag the loaded routine widget to the widget slot 14 to add the loaded routine widget. Referring to FIG. 3, the personal schedule widget 11 and the news widget 12 are added to the widget slot 14, and the music widget 13 is not added yet. The added widget may be deleted by dragging the added widget out of the widget slot 14. When the user presses an execution button 15, the navigation system 100 may execute the personal schedule widget 11 and the news widget 12 to perform the corresponding operation thereto. Before performing the operation, the execution order of the personal schedule widget 11 and the news widget 12 is determined. For example, assuming that the current time is 8:00 AM, the personal schedule widget 11 indicates a routine to move to Seoul Forest Trimage by 9:00 AM, and the news widget 12 indicates a routine to play the morning news at 8:30 AM. Thus, setting the destination as Seoul Forest Trimage may be performed first and then the morning news may be played.

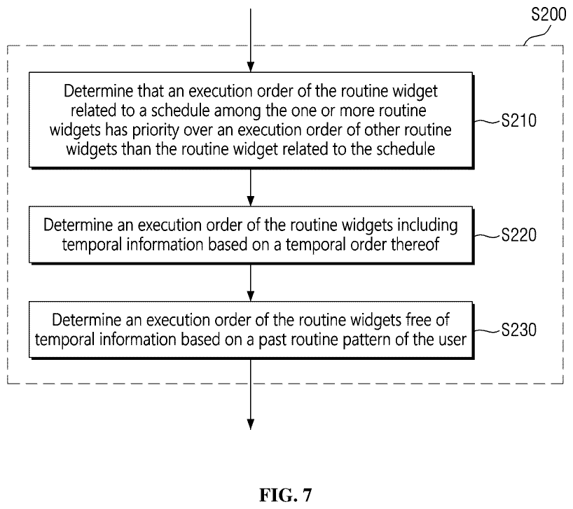

FIGS. 4 and 5 show examples of a routine widget execution screen 20 of the navigation system 100 of FIG. 1. In FIGS. 4 and 5, it is assumed that the personal schedule widget 11 of FIGS. 2 and 3 is executed first and the news widget 12 is executed next. Referring to FIG. 4, the personal schedule widget 11 among the routine widgets added to the widget slot 14 is executed. As a result of the execution of the personal schedule widget 11, the navigation system 100 may output a message 21 recommending that a location registered in the personal schedule widget 11 be set as the destination. When the user approves the recommendation (i.e., clicks “Yes”), the navigation system 100 may guide the user along the route to the location corresponding to the personal schedule widget 11. Thereafter, the navigation system 100 may execute the routine widget of the next order. On the contrary, when the user does not approve the recommendation (i.e., clicks “No”), the navigation system 100 may execute the routine widget of the next order.

Referring to FIG. 5, the news widget 12 among the routine widgets added to the widget slot 14 is executed. As a result of the execution of the news widget 12, the navigation system 100 may output a message 21 recommending to the user to play the news registered in the news widget 12. When the user approves the recommendation (i.e., presses “Yes”), the navigation system 100 may control the vehicle 200 or the user device 300 to play the news. On the contrary, when the user does not approve the recommendation (i.e., clicks “No”), the execution of the routine widget may be terminated because there are no more registered routine widgets based on FIG. 5. Then, the user may return to the routine widget setting screen 10 using the setting button 22.

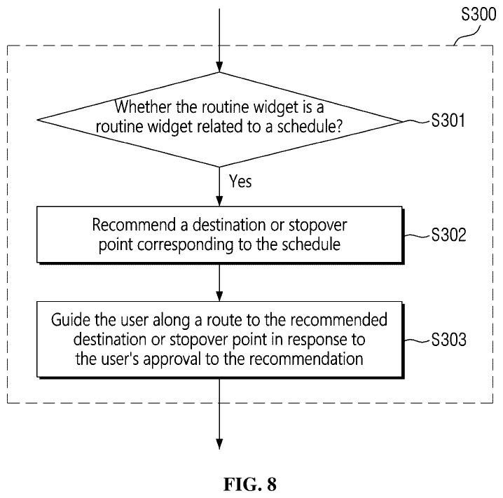

FIG. 6 is a flowchart illustrating a method for operating a navigation system based on a routine widget according to some embodiments of the present disclosure. For reference, FIG. 6 illustrates steps/operations performed in the navigation system 100 of FIG. 1. Therefore, in the descriptions set forth below, it may be understood that when a subject of a specific step/operation is omitted, the step/operation is performed in the navigation system 100 of FIG. 1. Furthermore, as described with reference to FIG. 1, the mobility apparatus 200 of FIG. 1 is assumed to be a vehicle. However, the present disclosure is not limited thereto, and some embodiments as described below may be applied to all mobility apparatuses 200 other than the vehicle. The description is made with reference to FIG. 1 to FIG. 5 along with FIG. 6 below.

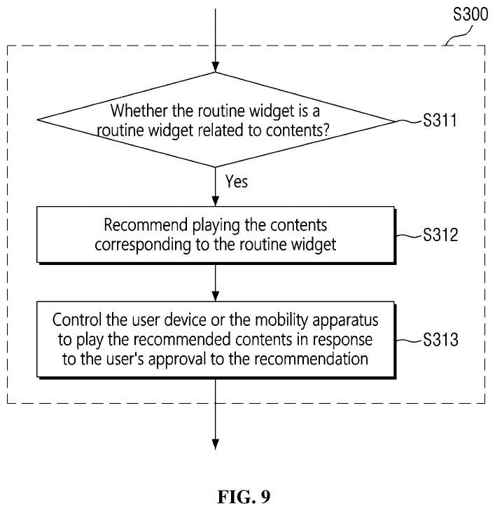

In operation S100, one or more routine widgets may be added to the widget slot of the navigation system 100. For example, one or more routine widgets may be loaded from the user device 300 to the navigation system 100, and the loaded routine widget may be added to the widget slot via a drag and drop. The routine includes the user's personal schedule, contents that the user plays periodically, places that the user visits periodically, and the user's periodic leisure activities, and the routine widget may include detailed information about such routines. The routine widget may be created and managed in the user device 300. when the detailed information of the routine widget is modified in the user device 300, the modification may be applied to the routine widget loaded in the navigation system 100. In operation S200, the execution order of the added routine widgets may be determined. Operation S200 is described with reference to FIG. 7.

FIG. 7 is a flowchart specifically showing operation S200 of determining the execution order of the routine widgets of FIG. 6. Referring to FIG. 7, in operation S210, the execution order of the routine widgets may be determined such that the routine widget related to the schedule may be executed prior to the other routine widgets that are not related to the schedule. Specifically, the execution order of the routine widgets may be determined such that the routine widget related to the final destination among the routine widgets related to the schedules may be executed prior to the routine widget related to the stopover point among the routine widgets related to the schedule. The execution order of the routine widgets related to the stopover point may be determined based on the temporal order thereof. In operation S220, the execution order of the routine widgets including temporal information among other routine widgets that are not related to the schedule may be determined based on the temporal order. Then, in operation S230, the execution order of the routine widgets that do not include temporal information may be determined based on the user's past routine pattern. Notwithstanding the above-described embodiments, the execution order of the routine widgets may be arbitrarily determined by the user.

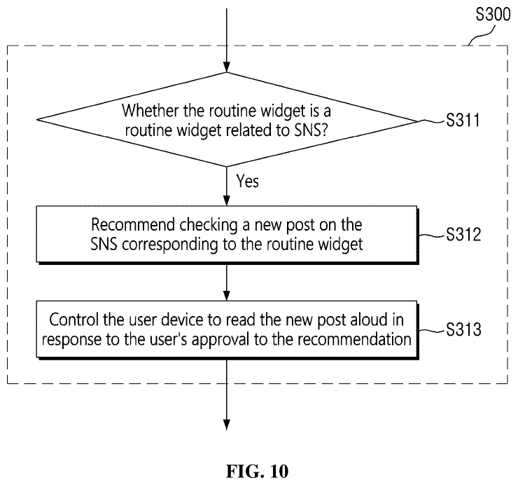

Returning to FIG. 6, in operation S300, the routine widget may be executed according to the determined execution order and the corresponding operation thereto may be processed. Hereinafter, various embodiments related to operation S300 are described with reference to FIGS. 8 to 10. FIGS. 8 to 10 are flowcharts specifically showing embodiments of the operation S300 for processing the operation corresponding to the routine widget.

Referring to FIG. 8, in operation S301, it may be determined whether the routine widget to be executed is a routine widget related to a schedule. When the routine widget to be executed is a routine widget related to a schedule (YES), in operation S302, a destination or a stopover point corresponding to the routine widget may be recommended. Thereafter, in operation S303, the system may guide the user along a route to the destination or stopover point recommended in response to the user's approval.

Referring to FIG. 9, in operation S311, it may be determined whether the routine widget to be executed is a routine widget related to contents. When the routine widget to be executed is related to contents (YES), in operation S312, contents playback corresponding to the routine widget may be recommended. Thereafter, in operation S313, the vehicle 200 or the user device 300 may be controlled to play the contents in response to the user's approval.

Referring to FIG. 10, in operation S321, it may be determined whether the routine widget to be executed is a routine widget related to SNS. When the routine widget is related to SNS (YES), in operation S322, it may be recommended that the user checks new posts of SNS corresponding to the routine widget. Thereafter, in operation S323, the user device 300 may be controlled to read the new post aloud in response to the user's approval. Although the embodiment of FIG. 10 is described based on SNS, the present disclosure is not limited thereto, and the same operations may be performed on any page that the user checks on a regular basis.

FIG. 11 is a block diagram showing a hardware configuration of a computing device 500 in which a navigation system based on a routine widget according to some embodiments of the present disclosure is implemented.

Referring to FIG. 11, the computing device 500 may include one or more processors 510, a bus 530, a communication interface 540, a memory 520 that loads a computer program executed by the processor 510 therein, and a storage 550 that stores a computer program 560 therein. However, only components related to an embodiment of the present disclosure are illustrated in FIG. 11. Therefore, a person of ordinary skill in the art in the technical field to which the present disclosure belongs may understand that other general components than the components as illustrated in FIG. 11 may be included in the computing device.

In other words, the computing device 500 may include various components in addition to the components as illustrated in FIG. 11. Furthermore, in some cases, the computing device 500 may be configured such that some of the components as illustrated in FIG. 11 are omitted. Hereinafter, each of the components of the computing device 500 is described.

The processor 510 may control all operations of the components of the computing device 500. The processor 510 may be configured to include at least one of a CPU (Central Processing Unit), an MPU (Micro Processor Unit), an MCU (Micro Controller Unit), a GPU (Graphics Processing Unit), or any further type of a processor well known in the technical field of the present disclosure. Furthermore, the processor 510 may perform computations of at least one application or program for executing operations/methods according to some embodiments of the present disclosure. The computing device 500 may have one or more processors.

Next, the memory 520 may store therein various data, commands, and/or information. The memory 520 may load therein the computer program 560 from the storage 550 to execute operations/methods according to some embodiments of the present disclosure. The memory 520 may be embodied as a volatile memory such as RAM. However, the present disclosure is not limited thereto.

Next, the bus 530 may provide a communication function between the components of the computing device 500. The bus 530 may be embodied as various types of buses such as an address bus, a data bus, and a control bus.

Next, the communication interface 540 may support wired and wireless Internet communication of the computing device 500. Furthermore, the communication interface 540 may support various communication schemes other than Internet communication. To this end, the communication interface 540 may be configured to include a communication module well known in the technical field of the present disclosure.

Next, the storage 550 may non-temporarily store therein one or more computer programs 560. The storage 550 may be configured to include a non-volatile memory such as Read Only Memory (ROM), Erasable Programmable ROM (EPROM), Electrically Erasable Programmable ROM (EEPROM), flash memory, a hard disk, a removable disk, or any form of computer-readable recording medium well known in the art to which the present disclosure belongs.

Next, the computer program 560 may include one or more instructions that cause the processor 510 to perform the operations/methods according to various embodiments of the present disclosure when being loaded into the memory 520. That is, the processor 510 may execute one or more loaded instructions to perform the operations/methods according to various embodiments of the present disclosure.

For example, the computer program 560 may include instructions for adding one or more routine widgets to the widget slot of the navigation system, instructions for determining the execution order of the added routine widgets, and instructions for executing each routine widget based on the determined execution order to perform a corresponding operation thereto. Furthermore, the computer program 560 may include instructions for determining the execution order of the routine widgets such that the routine widget related to the schedule may be executed prior to other routine widgets, instructions for determining the execution order of the routine widgets including temporal information based on the temporal order, and instructions for determining the execution order of the routine widgets not including temporal information based on a user's past routine pattern.

According to an embodiment of the present disclosure, under the interoperation between the user device such as a smartphone or smartwatch and the navigation system, the user's regular destination and stopover point setting, contents playback, SNS use, etc. may be effectively performed in an autonomous vehicle. According to an embodiment of the present disclosure, these operations are managed according to the routine widget. The matter added or modified in the user device may be immediately applied to the vehicle's navigation system. Thus, the addition and modification may be easily made.

Various embodiments and the effects thereof according to the present disclosure have been mentioned with reference to FIGS. 1 through 11. The effects according to the technical spirit of the present disclosure are not limited to those mentioned above, and other effects not mentioned should be clearly understood by one of ordinary skill in the art from the description below.

While all components comprising the embodiments of the present disclosure have been described as being combined or operating in conjunction, it should not be understood that the present disclosure is limited to such embodiments. That is, within the scope of the objectives of the present disclosure, all such components can selectively be combined and operate in one or more configurations.

Although operations are illustrated in a specific order in the drawings, it should not be understood that the operations must be performed in that specific order or sequentially, or that all the illustrated operations are required to achieve desired results. In certain circumstances, multitasking and parallel processing may be advantageous. Furthermore, the separation of various components in the described embodiments should not be understood as necessary, and the described program components and systems can generally be integrated into a single software product or packaged into multiple software products.

While the embodiments of the present disclosure have been described with reference to the attached drawings, it should be understood by those having ordinary skill in the art that the present disclosure can be implemented in other specific forms without departing from the technical spirit or essential characteristics thereof. Therefore, the described embodiments should be considered in all respects as illustrative and not restrictive. The scope of the present disclosure is to be interpreted by the following claims, and all technical spirits within the equivalent scope are to be interpreted as included within the rights of the present disclosure.

What is claimed is:

1. A method for operating a navigation system, the method being performed by a computing device, the method comprising:
adding at least one routine widget indicating a routine of a user to a widget slot of the navigation system;
determining an execution order of the at least one routine widget; and
executing the at least one routine widget based on the determined execution order to perform an operation corresponding to the routine of the user.

2. The method of claim 1, wherein the routine of the user includes at least one of a personal schedule of the user, contents periodically played by the user, a place periodically visited by the user, or a periodic SNS (Social Network Service) activity of the user,
wherein the at least one routine widget includes detailed information about the routine.

3. The method of claim 1, wherein when detailed information of the at least one routine widget is modified in a user device and the at least one routine widget includes a plurality of routine widgets, the modification is equally applied to the plurality of routine widgets added to the widget slot.

4. The method of claim 1, wherein adding the at least one routine widget to the widget slot includes:
loading the at least one routine widget from a user device; and
dragging the at least one loaded routine widget to the widget slot.

5. The method of claim 1, wherein the at least one routine widget includes a plurality of routine widgets, and
wherein determining the execution order of the at least one routine widget includes:
determining that an execution order of a routine widget related to a schedule, among the plurality of routine widgets, has priority over an execution order of other routine widgets of the plurality of routine widgets;
determining an execution order of a routine widget including temporal information, among the other routine widgets, based on a temporal order thereof; and
determining an execution order of a routine widget free of the temporal information, among the other routine widgets, based on a past routine pattern of the user.

6. The method of claim 1, wherein executing the at least one routine widget includes:
when the at least one routine widget is a routine widget related to a schedule, recommending a destination or stopover point corresponding to the schedule; and
guiding the user along a route to the recommended destination or stopover point in response to an approval to the recommendation.

7. The method of claim 1, wherein executing the at least one routine widget includes:
when the at least one routine widget is a routine widget related to contents, recommending playing the contents corresponding to the at least one routine widget; and
controlling a user device or a vehicle to play the recommended contents in response to an approval to the recommendation.

8. The method of claim 1, wherein executing the at least one routine widget includes:
when the at least one routine widget is a routine widget related to SNS (Social Network Service), recommending checking a new post on the SNS corresponding to the at least one routine widget; and
controlling a user device to read the new post aloud in response to an approval to the recommendation.

9. A computing device comprising:
a processor; and
a memory storing therein instructions,
wherein when the instructions are executed by the processor, the instructions cause the processor to:
add at least one routine widget indicating a routine of a user to a widget slot of a navigation system;
determine an execution order of the at least routine widget; and
execute the at least routine widget based on the determined execution order to perform an operation corresponding to the routine of the user.

10. The computing device of claim 9, wherein adding the at least one routine widget to the widget slot includes:
loading the at least one routine widget from a user device; and
dragging the at least one loaded routine widget to the widget slot.

11. The computing device of claim 9, wherein the at least one routine widget includes a plurality of routine widgets, and
wherein determining the execution order of the at least one routine widget includes:
determining that an execution order of a routine widget related to a schedule, among the plurality of routine widgets, has priority over an execution order of other routine widgets of the plurality of routine widgets;
determining an execution order of a routine widgets including temporal information, among the other routine widgets, based on a temporal order thereof; and
determining an execution order of a routine widget free of the temporal information, among the other routine widgets, based on a past routine pattern of the user.

12. The computing device of claim 9, wherein executing the at least one routine widget includes:
when the at least one routine widget is a routine widget related to a schedule, recommending a destination or stopover point corresponding to the schedule; and
guiding the user along a route to the recommended destination or stopover point in response to an approval to the recommendation.

13. The computing device of claim 9, wherein executing the at least one routine widget includes:
when the at least one routine widget is a routine widget related to contents, recommending playing the contents corresponding to the at least one routine widget; and
controlling a user device or a vehicle to play the recommended contents in response to an approval to the recommendation.

14. The computing device of claim 9, wherein executing the at least one routine widget includes:
when the at least routine widget is a routine widget related to SNS (Social Network Service), recommending checking a new post on the SNS corresponding to the at least one routine widget; and
controlling a user device to read the new post aloud in response to an approval to the recommendation.

15. A system comprising:
a mobility apparatus;
a user device configured to generate a plurality of routine widgets indicating a routine of a user; and
a navigation system configured to:
load and add the plurality of routine widgets to a widget slot;
determine an execution order of the plurality of routine widgets; and
execute the plurality of routine widgets based on the determined execution order to perform a corresponding operation thereto.

16. The system of claim 15, wherein when detailed information of the plurality of routine widgets is modified in the user device, the modification is equally applied to the plurality of routine widgets added to the widget slot of the navigation system.

17. The system of claim 15, wherein the navigation system is further configured to:
determine that an execution order of a routine widget related to a schedule, among the plurality of routine widgets, has priority over an execution order of other routine widgets of the plurality of routine widgets;
determine an execution order of a routine widget including temporal information, among the plurality of routine widgets, based on a temporal order thereof, and
determine an execution order of a routine widget free of the temporal information, among the plurality of routine widgets, based on a past routine pattern of the user.

18. The system of claim 15, wherein the navigation system is further configured to:
when a routine widget among the plurality of routine widgets is related to a schedule, recommend a destination or stopover point corresponding to the schedule; and
guide the user along a route to the recommended destination or stopover point in response to an approval of the user to the recommendation.

19. The system of claim 15, wherein the navigation system is further configured to:
when a routine widget among the plurality of routine widgets is related to contents, recommend playing the contents corresponding to the routine widget; and
control the user device or the mobility apparatus to play the recommended contents in response to an approval of the user to the recommendation.

20. The system of claim 15, wherein the navigation system is further configured to:
when a routine widget among the plurality of routine widgets is related to SNS (Social Network Service), recommend checking a new post on the SNS corresponding to the routine widget; and
control the user device to read the new post aloud in response to an approval of the user to the recommendation.
